(19) United States
(12) Patent Application Publication
(10) Pub. No.: US 2026/0034684 A1
(43) Pub. Date: Feb. 5, 2026

(54) ROBOTIC HAND DEVICE WITH THENAR MUSCLES

(71) Applicants: Teh San SUN, Taipei City (TW); Lee-Fei CHEN, Taipei City (TW); Shin Fang Global CO., LTD., Taipei City (TW)

(72) Inventors: Teh San SUN, Taipei City (TW); Lee-Fei CHEN, Taipei City (TW)

(21) Appl. No.: 18/793,118

(22) Filed: Aug. 2, 2024

(51) Int. Cl. B25J 15/00; B25J 15/02

(52) U.S. Cl. CPC B25J 15/0009; B25J 15/0233

(57) ABSTRACT

The present invention is a robotic hand device with thenar muscles, comprising a finger unit, a palm unit, a thenar unit, a first drive unit, a second drive unit, and a processor unit. When the processor unit issues a gripping instruction, the processor unit drives the finger units and the palm unit through the first drive unit to bend towards a central area of the palm until the finger units and the palm unit grip the object, and the processor unit drives the thenar unit through the second drive unit to move towards the central area of the palm until the thenar unit leans against the object. In this way, the robot hand device with thenar muscles using lead screw mechanism can firmly grip the object through the thenar unit in a more stable manner to improve a dynamic holding stability and to reduce risks of dropping the object.

### BACKGROUND OF THE INVENTION

### 1. Field of the Invention

The present invention relates to a robotic hand device, in particular, a robotic hand device with thenar muscles that improves a dynamic grip stability.

### 2. Description of the Related Art

With the development of robot technology, robots can perform more and more tasks, especially in catering. Robots can imitate the movements of professional chefs and perform cooking actions such as pan-frying, boiling, stir-frying, and deep-frying.

When a robot imitates the cooking actions of a professional chef, the robot often needs to hold the handle of the cookware through the robot's hand device to perform cooking techniques such as cookware tossing. However, the current robot hand device is designed with only 5 fingers to generate a grip force, which is only able to steadily hold the handle of the cookware in static positions. When the robot hand device needs to perform cooking techniques such as cookware tossing, a large impact force exerted by movements of the cookware is likely beyond the robot hand device's steady grip; therefore, the robot hand device cannot steadily hold the moving cookware, resulting in the cookware not operated in accordance with expected trajectories. Accordingly, the robot cannot stably imitate the cooking actions of professional chefs. In view of the above, it is demanded that the robot hand device be improved to overcome the above-mentioned shortcomings of not being able to stably hold a cookware being tossed.

### SUMMARY OF THE INVENTION

In view of the above problems, the present invention provides a robotic hand device with thenar muscles, which is capable of improving the dynamic grip stability of the robotic hand device with thenar muscles, so as to reduce the risk of dropping the cookware.

The robotic hand device with thenar muscles, comprises:
a plurality of finger units;
a palm unit, pivotally connected to the finger units;
a thenar unit, disposed on a side of the palm unit facing a central area of the palm of the robotic hand device;
a first drive unit, connected to the finger units and the palm unit;
a second drive unit, connected to the thenar unit;
a processor unit electrically connected to the first drive unit and the second drive unit;
wherein, when the processor unit issues a gripping instruction, the processor unit drives the finger units and the palm unit through the first drive unit to bend towards the central area of the palm until the finger units and the palm unit grip an object, and the processor unit drives the thenar unit through the second drive unit towards the central area of the palm until the thenar unit leans against the object.

The robotic hand device with thenar muscles is further provided with the thenar unit, and the thenar unit moves towards the central area of the palm and against the object gripped by the robotic hand device with thenar muscles when the processor unit issues a gripping instruction; as a result, a stability of holding the object by the robotic hand device with thenar muscles is strengthened in general, and the dynamic grip stability of the robotic hand device with thenar muscles is also improved, which reduces the risk of dropping cookware.

In order to make the above objects, features and advantages of the present invention more apparent and easier to understand, the following embodiments, together with the accompanying drawings, are described in detail as follows.

### BRIEF DESCRIPTION OF THE DRAWINGS

FIG. 1 illustrates a block diagram of a robotic hand device with thenar muscles of the present invention;

FIG. 2 illustrates a front schematic view of the robotic hand device with thenar muscles of the present invention;

FIG. 3 illustrates a schematic side view of the robotic hand device with thenar muscles of the present invention;

FIG. 4 illustrates a schematic side view of the robotic hand device with thenar muscles holding a pan handle; and

FIG. 5 illustrates a perspective view of the robotic hand device with thenar muscles holding a pan handle.

### DETAILED DESCRIPTION OF THE INVENTION

The technical contents, features and effects of the present invention will be clearly presented in the following detailed description of the preferred embodiment with reference to the drawings. In addition, the directional terms mentioned in the following embodiments, such as: up, down, left, right, front, back, bottom, top, etc., are only relative directions with reference to the drawings, and do not represent absolute directional positions; therefore, the directional terms used are for the convenience of illustrating their relative positional relationships, and are not intended to impose limitations on the present invention.

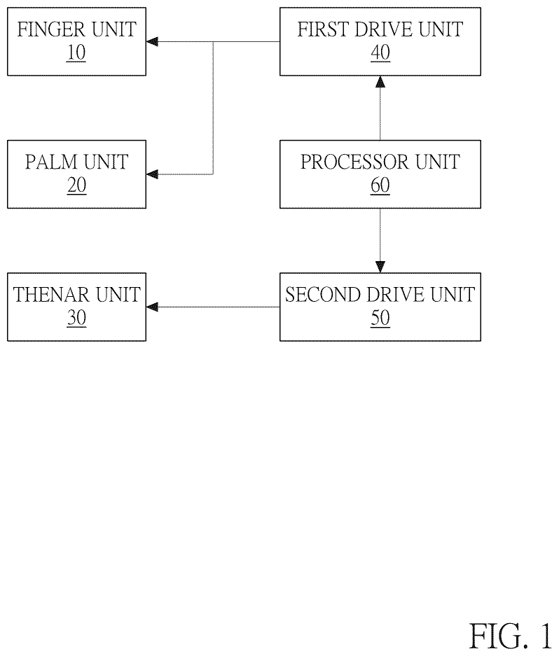

Referring to FIGS. 1, 2 and 3, the present invention provides a robotic hand device with thenar muscles. The robotic hand device with thenar muscles includes a plurality of finger units 10, a palm unit 20, a thenar unit 30, a first drive unit 40 (not shown in the drawings), a second drive unit 50, and a processor unit 60.

The palm unit 20 is pivotally connected to the finger units 10 respectively. The thenar unit 30 is disposed on a side 22 of the palm unit 20 facing a central area of the palm 21. The first drive unit 40 is connected to the finger units 10 and the palm unit 20. The second drive unit 50 is connected to the thenar unit 30. The processor unit 60 is electrically connected to the first drive unit 40 and the second drive unit 50.

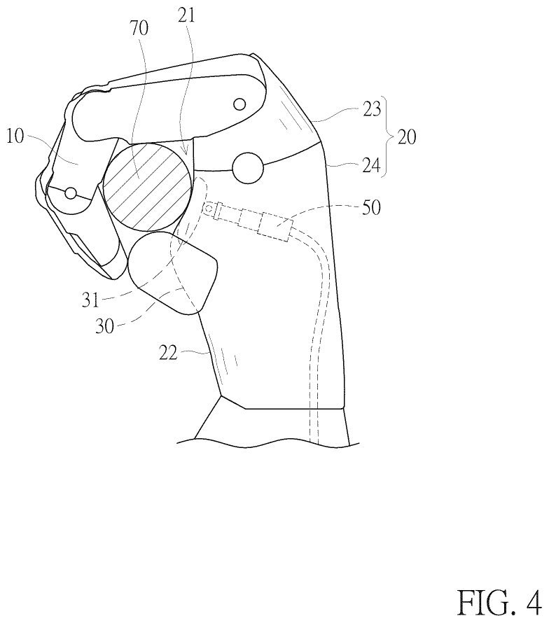

Please further refer to FIG. 4. When the processor unit 60 issues a gripping instruction, the processor unit 60 drives the finger units 10 and the palm unit 20 through the first drive unit 40 to bend towards the central area of the palm 21 until the finger units 10 and the palm unit 20 grip on an object 70, and the processor unit 60 drives the thenar unit 30 to move towards the central area of the palm 21 through the second drive unit 50 until the thenar unit 30 leans against the object 70. In this embodiment, an end of the second drive unit 50 facing the thenar unit 30 is additionally provided with a resisting piece 31 for pushing against the thenar unit 30 so that the thenar unit 30 moves towards the central area of the palm 21.

Since when the processor unit 60 issues the gripping instruction, the processor unit 60, in addition to controlling the finger units 10 and the palm unit 20 to bend towards the central area of the palm 21 to grip the object 70, further controls the thenar unit 30 to move towards the central area of the palm 21 to lean against the object 70. Thereby, the robotic hand device with thenar muscles can further clamp the object 70 through the thenar unit 30 to firmly grip the object 70 in a more stable manner, and improve a dynamic grip stability of the robotic hand device with thenar muscles to reduce the risk of dropping the object 70.

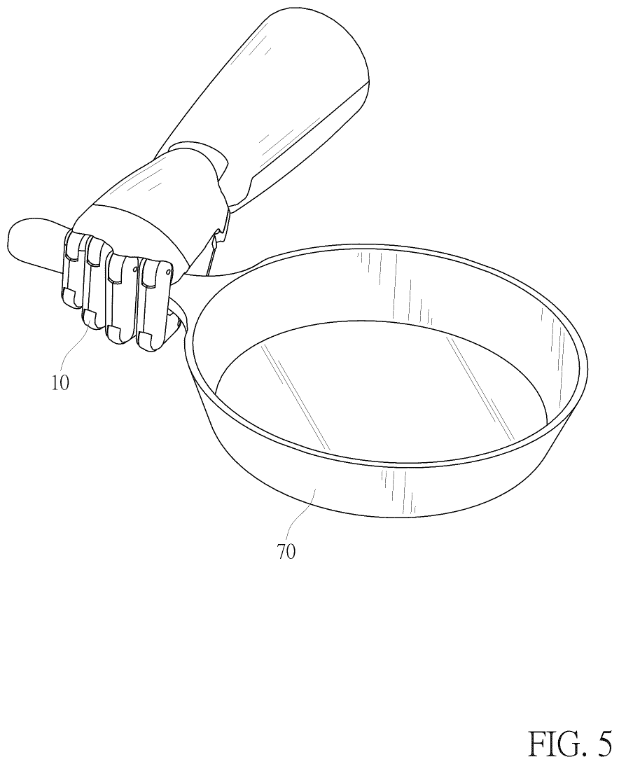

Please refer to FIG. 5. For example, the object 70 can be a pan, and the robotic hand device with thenar muscles is used to hold the pan handle.

In addition, in this embodiment, the thenar unit 30 is disposed on the second part of the palm unit 20, and the thenar unit 30 is a silicone block or a rubber block.

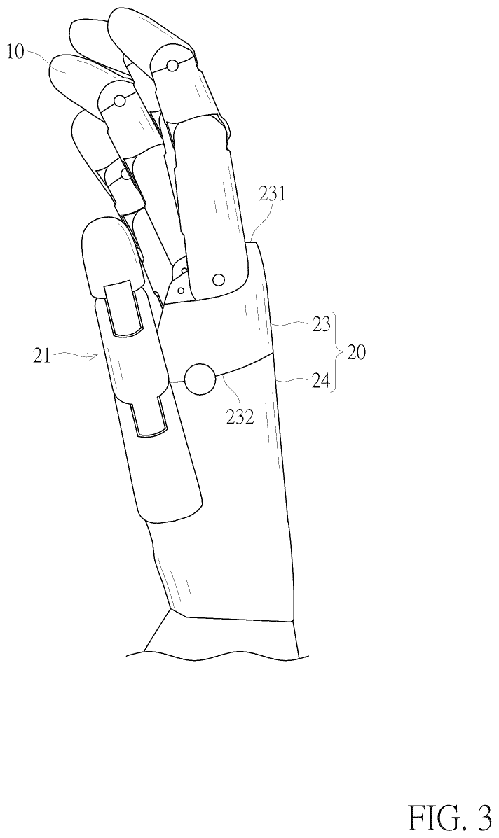

As shown in FIG. 3, when the processor unit 60 issues a releasing instruction, the processor unit 60 drives the finger units 10 and the palm unit 20 to unfold from the central area of the palm 21 through the first drive unit 40, until the finger units 10 and the palm unit 20 return to an open palm position, and the processor unit 60 drives the thenar unit 30 to move away from the central area of the palm 21 through the second drive unit 50 until the thenar unit 30 is resumed to an original position.

When the processor unit 60 issues the releasing instruction, the processor unit 60 not only controls the finger units 10 and the palm unit 20 to unfold from the central area of the palm 21 to release the object 70, but further controls the thenar unit 30 to move away from the central area of the palm 21 to leave the object 70, and to resume to the original position. In this way, the robotic hand device with thenar muscles can return to the open palm state, and is ready to grip other objects. In this embodiment, the original position denotes the original position of the thenar unit 30 when the robotic hand device with thenar muscles is in the open palm state.

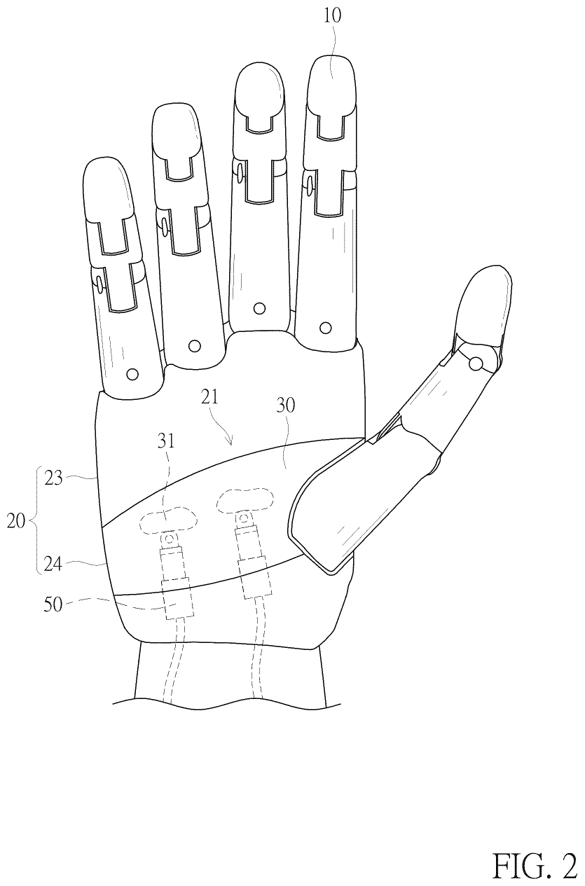

Furthermore, as shown in FIGS. 2 and 3, the palm unit 20 also comprises a first part 23 of the palm and a second part 24 of the palm. The first part 23 of the palm has a first connection end 231 and a second connection end 232 opposite to each other. The first connection end 231 is pivotally connected to the finger units 10. The second part 24 of the palm is pivotally connected to the second connection end 232 of the first part 23 of the palm.

Since the palm unit 20 also comprises the first part 23 of the palm and the second part 24 of the palm pivotally connected to each other, when the processor unit 60 issues the gripping instruction, the processor unit 60 in addition to controlling bending the finger units 10 and the palm unit 20 towards the central area of the palm 21 and controlling the movement of the thenar unit 30 towards the central area of the palm 21, the processor unit 60 further controls the first part 23 of the palm and the second part 24 of the palm to bend together towards the central area of the palm 21. Thereby, the palm unit 20 of the robotic hand device with thenar muscles can better fit to the object 70 to further improve the gripping strength of the robotic hand device with thenar muscles, and to increase the dynamic grip stability to reduce the risk of dropping the object 70.

In this embodiment, the first drive unit 40 comprises a plurality of steel wires, and the steel wires are tightened or released through a first motor element to drive the finger units 10 and the palm unit 20, such that the first part 23 of the palm and the second part 24 of the palm are bent towards the central area of the palm 21. The second drive unit 50 comprises a lead screw, and a second motor element rotates the lead screw to drive the thenar unit 30 to move to lean against the object 70 or to return to the original position. The reason why the second drive unit 50 uses a lead screw is because physical properties of the lead screw make it impossible for the object to push the lead screw backward (i.e. back drive), so the object 70 will be fixed in a certain position.

In summary, the above is only a description of the implementation modes or examples of the technical means used in the present invention to present a solution to a problem, and is not intended to limit the claims of the present invention. That is to say, all the changes and modifications that are consistent with the meaning of the claims of the present invention or in accordance with the claims of the present invention are covered by the claims of the present invention.

Although the present invention has been disclosed as above by way of a preferred embodiment, it is not intended to limit the present invention, and any one skilled in the art may make certain changes and modifications without departing from the spirit and scope of the present invention, and therefore the scope of protection of the present invention shall be subject to the scope of the appended patent claims as defined herein.

What is claimed is:

1. A robotic hand device with thenar muscles, comprising:
a plurality of finger units;
a palm unit, pivotally connected to the finger units;
a thenar unit, disposed on a side of the palm unit facing a central area of the palm;
a first drive unit, connected to the finger units and the palm unit;
a second drive unit, connected to the thenar unit;
a processor unit electrically connected to the first drive unit and the second drive unit;
wherein, when the processor unit issues a gripping instruction, the processor unit drives the finger units and the palm unit through the first drive unit to bend towards the central area of the palm of the robotic hand device until the finger units and the palm unit grip an object, and the processor unit drives the thenar unit through the second drive unit towards the central area of the palm until the thenar unit leans against the object.

2. The robot hand device with thenar muscles as claimed in claim 1, wherein when the processor unit issues a releasing instruction, the processor unit drives the finger units and the palm unit to unfold from the central area of the palm through the first drive unit, until the finger units and the palm unit are resumed to an open palm position, and the processor unit drives the thenar unit through the second drive unit to move away from the central area of the palm until the thenar unit is resumed to an original position.

3. The robot hand device with thenar muscles as claimed in claim 1, wherein the palm unit comprises:
a first part of the palm, having a first connection end and a second connection end opposite to each other; wherein the first connection end is pivotally connected to the finger units;
a second part of the palm, pivotally connected to the second connection end of the first part of the palm.

4. The robot hand device with thenar muscles as claimed in claim 3, wherein the thenar unit is disposed on the second part of the palm of the palm unit.

5. The robot hand device with thenar muscles as claimed in claim 1, wherein the first drive unit comprises a plurality of steel wires.

6. The robot hand device with thenar muscles as claimed in claim 1, wherein the second drive unit comprises at least one lead screw.

7. The robot hand device with thenar muscles as claimed in claim 1, wherein the thenar unit comprises a silicone block or a rubber block.
